(19) United States
(12) Patent Application Publication
(10) Pub. No.: US 2005/0097574 A1
(43) Pub. Date: May 5, 2005

(54) Modular, robust, component user interface framework

(75) Inventors: Conor Morrison, Seattle, WA (US); Sivaprasad Padisetty, Redmond, WA (US); Huaming Wang, Sammamish, WA (US); Nicholas Scott Newland, Kirkland, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/696,867

(22) Filed: Oct. 30, 2003

(51) Int. Cl. G06F 9/44

(52) U.S. Cl. 719/328; 717/107; 717/120

(57) ABSTRACT

A computer-implemented method of generating a componentized user interface is provided. The componentized user interface may include a framework and a plurality of plug-ins to provide users a method to customize the user interface. A shell that is linked to the framework hosts the plurality of plug-ins. A shell adapter may be utilized to provide an interface between the shell and the plurality of plug-ins.

### FIELD OF THE INVENTION

Aspects of the present invention relate to a modular user interface framework. More specifically, aspects of the present invention provide a componentized user interface that includes a framework and plug-ins that provide users a method to customize user interfaces.

### BACKGROUND

User interfaces such as graphical user interfaces are used by computer applications to accommodate the interaction between computer applications and users of computer applications. The goal of a user interface is to communicate information from the computer application to the user and from the user to the computer application. Most computer applications are packaged with user interfaces that were specifically designed for the particular computer application or hosting environment. These specifically designed user interfaces may only allow a user to make minor modifications to the user interface. Currently designed user interfaces have several disadvantages. One disadvantage is that current user interface designs are not modular or componentized and therefore specific pieces of these user interfaces cannot be used in a variety of different computer applications or hosting environments. This drawback may prevent a user from obtaining the functionality of specific user interface elements in various different computer applications or hosting environments. In addition, a user may receive additional functionality that is not required and therefore not cost effective.

For example, a tool bar is a standard graphical user interface element that is employed in most current software applications. Generally, a toolbar appears to the user as a single row or column of icons or text on a computer monitor. The icons or text represent various program functions or commands that the computer application understands. The user selects the function or command represented by the icon or text and the computer application or hosting environment carries out the program function or command. However, this same toolbar that contains various function or commands may not be supported in other computer applications or hosting environments as the other computer applications or hosting environments may have been written using different programming languages from that of the program functions or commands of the toolbar. In addition, the particular user interface may not allow for the addition of such additional toolbars.

Therefore, there is a need in the art for a system and method that allows a user to utilize user interface elements in different computer applications or hosting environment without having to rewrite the underlying code.

### BRIEF SUMMARY

Aspects of the present invention address one or more of the issues mentioned above, thereby providing a componentized user interface that may be customized to fit a user's specific needs. A framework provides a first set of interface elements for the componentized user interface. The interface elements provided by the framework are common interface elements to a plurality of plug-ins. A second and third set of interface elements are provided by a first plug-in and a second plug-in, respectively. A shell that is linked to the framework hosts the first and the second plug-ins. A shell adapter provides an interface between the shell and the first plug-in and between the shell and the second plug-in in order to utilize both the second and third set of interface elements.

### BRIEF DESCRIPTION OF THE DRAWINGS

Aspects of the present invention are described with respect to the accompanying figures, in which like reference numerals identify like elements, and in which:

FIG. 1 illustrates a functional block diagram of a conventional general-purpose computer system;

FIG. 2 illustrates a system providing a componentized user interface in accordance with an embodiment of the invention;

FIG. 3 illustrates a screen shot illustrating a user interface shell of a componentized user interface in accordance with an embodiment of the invention;

FIG. 4 illustrates a system providing a componentized user interface for use in multiple applications and hosting environments;

FIG. 5 illustrates a computer-implemented method of generating a componentized user interface in accordance with an embodiment of the invention;

FIG. 6 illustrates a user interface being initialized in accordance with the present invention;

FIG. 7 illustrates a plug-in being added to a plug-in directory of a user interface in accordance with an embodiment of the invention;

FIG. 8 illustrates a plug-in being selected and the user interface response in accordance with an embodiment of the invention;

FIG. 9 illustrates the addition of a second plug-in to the plug-in directory in accordance with an embodiment of the invention;

FIG. 10 illustrates a plug-in being selected and the user interface response in accordance with an embodiment of the invention;

FIG. 11 illustrates another plug-in being selected and the user interface response in accordance with an embodiment of the invention;

FIG. 12 illustrates the activation of a plug-in by selection of the plug-in window and the user interface response in accordance with an embodiment of the invention;

FIG. 13 illustrates the selection of a toolbar button in accordance with an embodiment of the invention; and

FIG. 14 illustrates the sending of a message by the framework in accordance with an embodiment of the invention.

### DETAILED DESCRIPTION

Exemplary Operating Environment

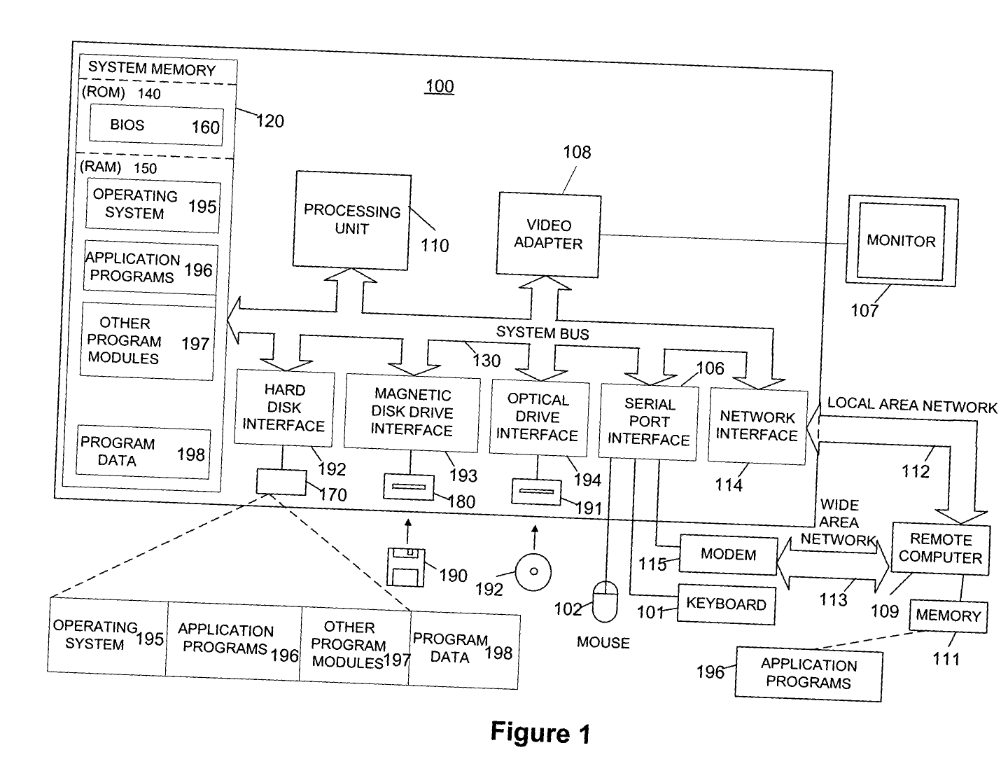

FIG. 1 is a functional block diagram of an example of a conventional general-purpose digital computing environment that can be used to implement a componentized user interface in accordance with various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used. The existence of any of various well-known protocols such as TCP/IP, Ethernet, FTP, HTTP, Bluetooth, IEEE 802.11X and the like is presumed, and the system can be operated in a client-server configuration to permit a user to retrieve web pages from a web-based server. Any of various conventional web browsers can be used to display and manipulate data on web pages.

### DESCRIPTION OF ILLUSTRATIVE EMBODIMENTS

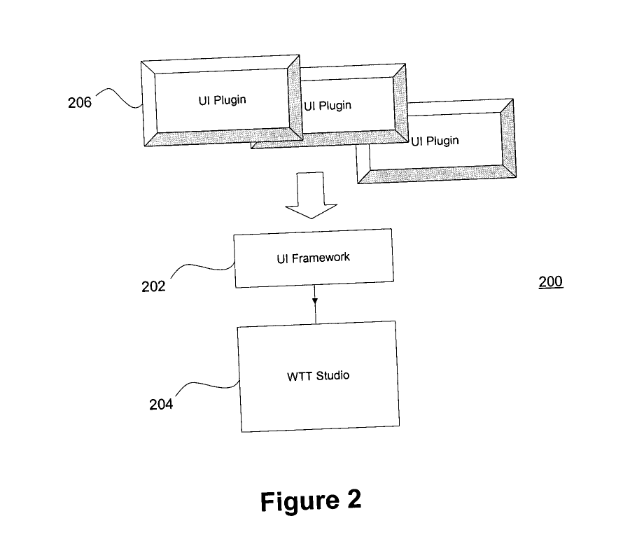

FIG. 2 illustrates a system 200 that provides a componentized and extensible user interface in accordance with an embodiment of the invention. A user interface framework 202 may allow a user to interact with a computer application or hosting environment such as Windows® Testing Technologies Studio 204 (WTT Studio). In the embodiment of FIG. 2, the user interface framework 202 is being utilized with a single computer application or hosting environment 204. Those skilled in the art will realize that the system of FIG. 2 can be utilized with numerous applications or hosting environments and that Windows® Testing Technologies Studio is utilized for purposes of illustration.

In the embodiment of FIG. 2, the user interface framework 202 loads various interface plug-ins 206 to customize the user interface according to the specific requirements of the user. For example, the customization of the user interface may create menu items, toolbar buttons, and status bar panels according to the instructions of the executed user interface plug-ins 206. The user interface framework 202 manages the user interface plug-ins 206. Specifically, the user interface plug-ins 206 may comprise modules that are activated by a user selecting menu choices on a user interface framework menu.

The user interface framework 202 may be an overall construct that controls the hierarchical organization of the user interface plug-ins 206. Communications channels may be provided by Microsoft® NET common language runtime platform so that the user interface plug-ins 206 may talk to each other and the user interface framework 202. In addition, the user interface framework 202 provides a first set of interface elements that may be common to all of the user interface plug-ins 206. For example, the user interface framework 202 may contain code for the opening and saving of files. In this manner, each user interface plug-ins 206 may not be required to duplicate functionality that may be common to numerous user interface plug-ins 206, as the functionality may be located in the user interface framework 202.

The user interface framework 202 may be configured to discover the user interface plug-ins 206 upon initialization through the utilization of a user interface component loader (not shown). The user interface component loader discovers the user interface plug-ins 206 and loads the use interface plug-ins 206 into a plug-in directory. Also, if the user interface framework encounters an error when loading a user interface plug-in, the user interface plug-in may be flagged and the user notified of the error. In addition, the user interface framework 202 may not be aware of the existence of a particular user interface plug-in until initialization or runtime.

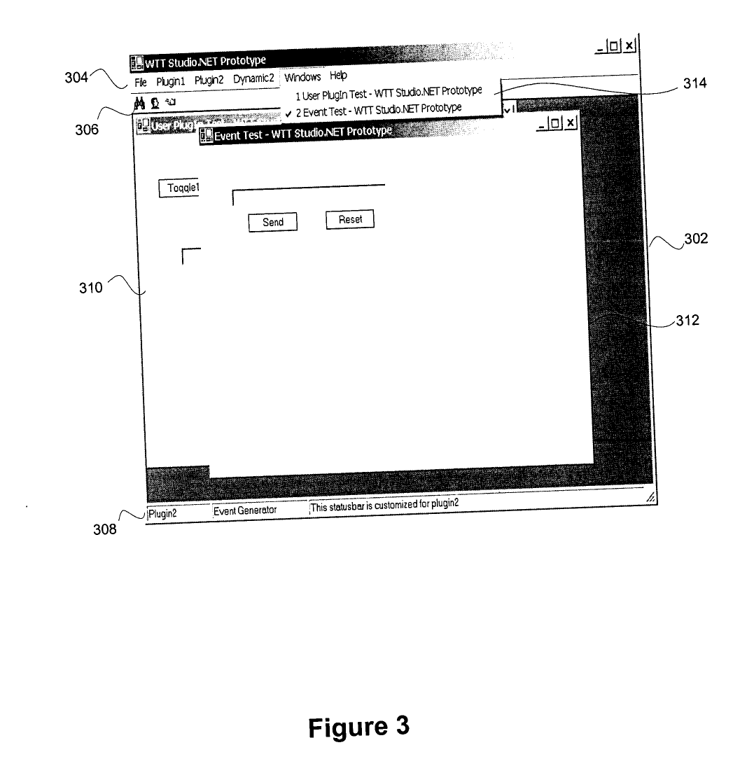

The user interface plug-ins 206 are hosted by a computer application that provides a shell to host the user interface plug-ins 206. For example, FIG. 3 shows a screen shot of one embodiment of a user interface shell 302. The user interface shell 302 may be a typical MDI window that allows for the displaying of a menu bar 304, a toolbar 306, and a status bar 308 in the user area of the user interface shell 302. A shown in FIG. 3 on the status bar 308, a plug-in named Plugin2 is active and the status bar has been customized for Plugin2. In addition, the menu bar 304 shows that two different plug-ins named Plugin1 and Plugin2 may have been loaded into user interface shell 302. A user can activate a plug-in by clicking a particular menu item. For example, a user can activate Plugin2 of FIG. 3 by selecting the “Event Test—WTT Studio.NET Prototype” window 312. As a user interacts with a plug-in, the plug-in may dynamically update the user interface shell 302 according to its state change.

Each user interface plug-in of the present invention may be implemented with the use of two files. A first file may provide an interface between the framework and the plug-in. The first file may be in the form of an executable file such as a DLL file. The second file may be written in a mark-up language such as XML. The second file may describe the attributes of the plug-in. The second file may also comprise menu elements that may include a toolbar, a status bar, and a menu bar. One skilled in the art will realize that other mark-up languages can be utilized to describe the attributes of the plug-ins such as a standard generalized markup language (SGML).

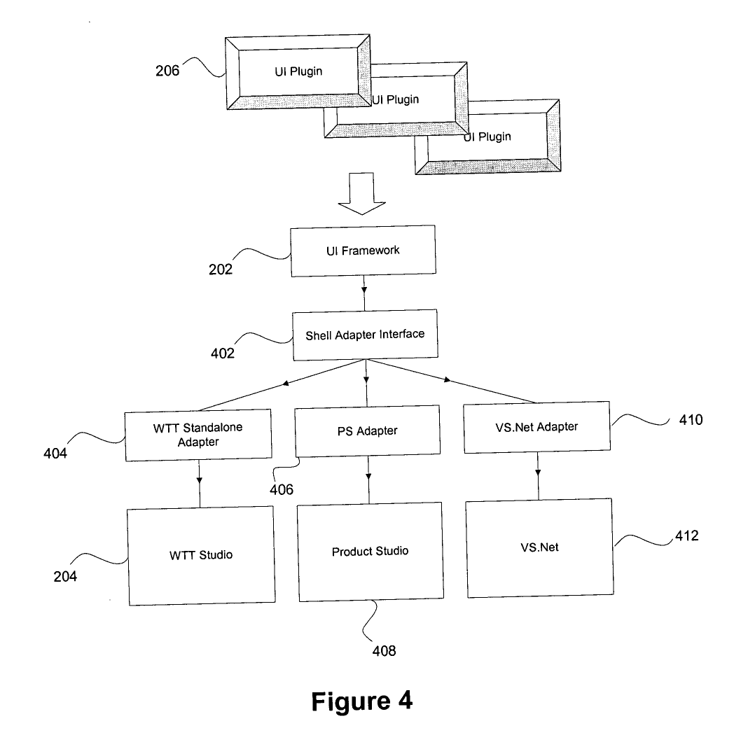

FIG. 4 illustrates a system providing a componentized user interface for use in numerous computer applications and hosting environments. In the embodiment of FIG. 4, a shell adapter interface 402 provides an interface between the user interface framework 202 and the various application specific adapters 404, 406, and 410. To support the utilization of user interface plug-ins 206 in a plurality of computer applications and hosting environments, a layer of abstraction may be introduced that insulates the user interface plug-ins 206 from the applications or hosting environments. In this manner, user interface plug-ins 206 may be utilized with minimal, if any, coding changes to the plug-ins 206. For example, FIG. 4 illustrates three applications or hosting environments namely WTT Studio 204, Product Studio 408, and Visual Studio.NET 412 (VS.Net). Each of these applications WTT Studio 204, Product Studio 408, and VS.Net 412 may want to utilize plug-ins 206 in their hosting environments. One skilled in the art will appreciate that other numerous computer applications or hosting environments may also be utilized to implement aspects of the invention.

In order for plug-ins 206 to be hosted in the various computer applications or hosting environments, an adapter for each application and hosting environment may be utilized. For example, a WTT Standalone Adapter 404 may enable WTT Studio 204 to utilize plug-ins 206 in the WTT Studio hosting environment 204. The WTT standalone adapter 404 may map the functions or interface elements of the user interface plug-ins 206 to corresponding functions or interface elements in WTT Studio hosting environment 204. The mapping may enable the user interface plug-ins 206 to be utilized in various computer applications and hosting environments. For example, a Product Studio adapter 406 may enable the plug-ins 206 to be utilized in Product Studio 408. Similarly, a Visual Studio.Net adapter 410 may enable the plug-ins 206 to be utilized in the Visual Studio hosting environment 412.

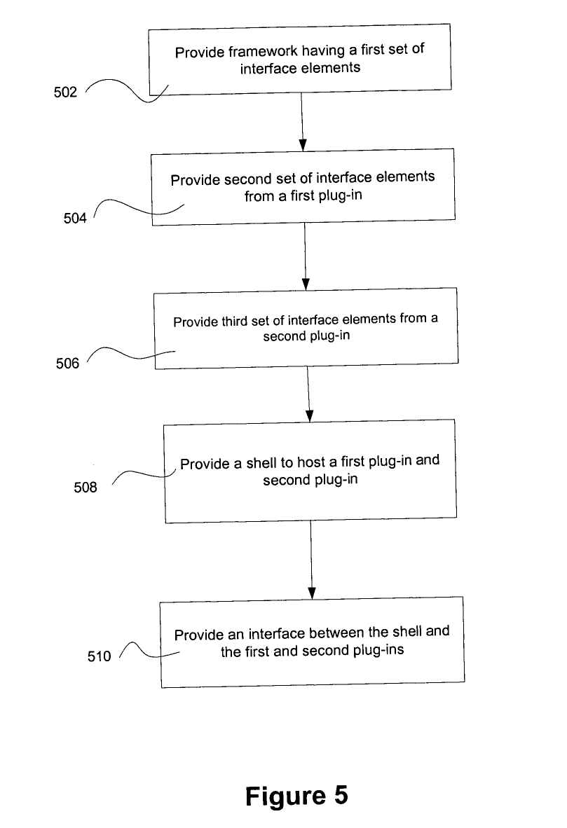

FIG. 5 illustrates a computer-implemented method of FIG. 4 for the generation of a componentized user interface in accordance with an embodiment of the invention. In step 502, a user interface framework 202 is provided having a first set of interface elements. The interface elements of user interface framework 202 may be comprised of interface elements that are common to plug-ins 206 eliminating duplicate functionality in each of the plug-ins 206. The utilization of the user interface framework 202 for common interface elements may save plug-in development time and memory allocation.

In step 504, a second set of interface elements may be provided by a first plug-in that may be linked to the user interface framework 202. Similarly, in step 506, a third set of interface elements may be provided by a second plug-in that may be linked to user interface framework 202. In step 508, a shell linked to the user interface framework 202 may be provided to host the first and second plug-ins. In FIG. 4, the shell may comprise WTT Studio 204, Product Studio 408, or VS.NET 412. Finally, in step 510 an interface may be provided between the shell and the first plug-in and between the shell and the second plug-in. The interface may be used in order to utilize the second and third set of interface elements. The interface may take the form of an adapter such as the WTT Standalone Adapter 404, PS Adapter 406, and VS.Net Adapter 410 of FIG. 4.

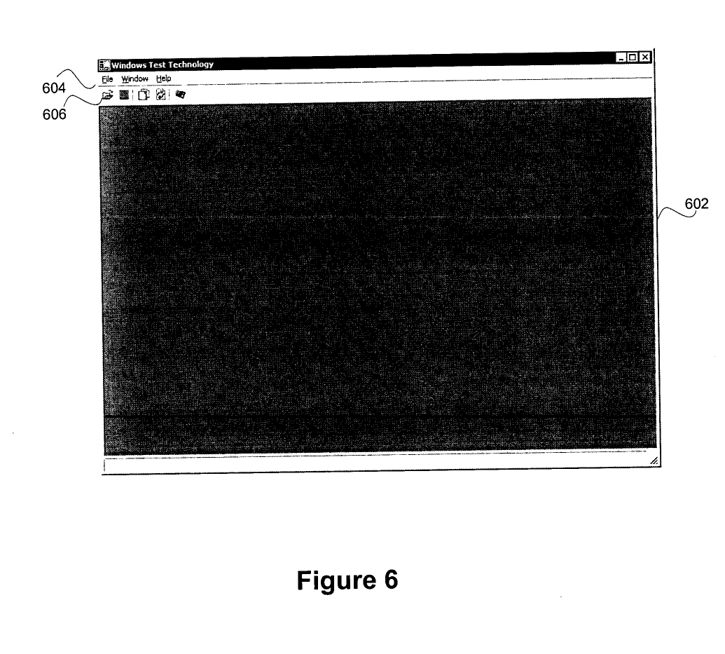

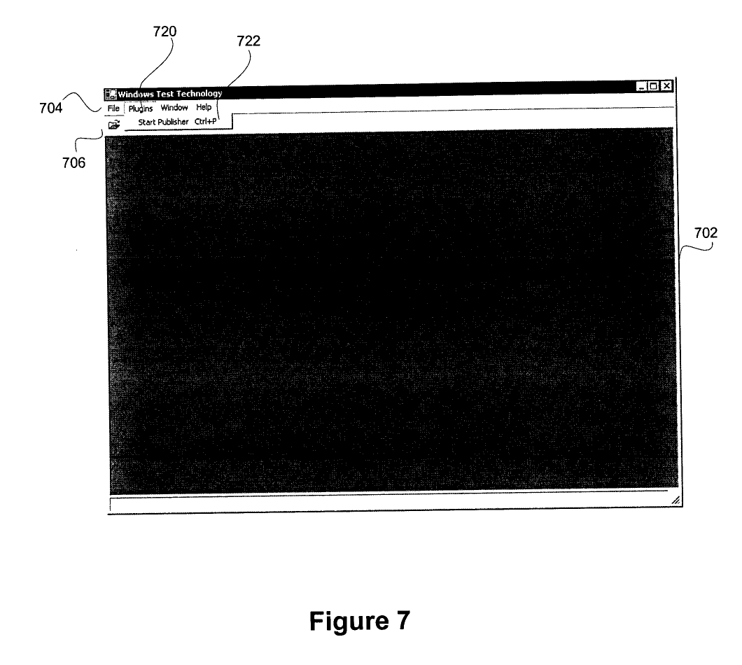

FIGS. 6 through 14 illustrate a componentized user interface in accordance with the present invention. In FIG. 6, a user interface shell 602 is displayed that includes a menu bar 604 and a toolbar 606. As shown in FIG. 6, the user interface shell 602 does not indicate the existence of any plug-ins. In FIG. 7, a plug-in named ‘Publisher’ may be added to a Plugins directory 720. A list of the added plug-ins to the user interface shell 702 may be discovered through the use of drop down menu 722. As illustrated in FIG. 7, the user interface shell 702 may be updated or customized upon the addition of the ‘Publisher’ plug-in to the Plugins directory 720.

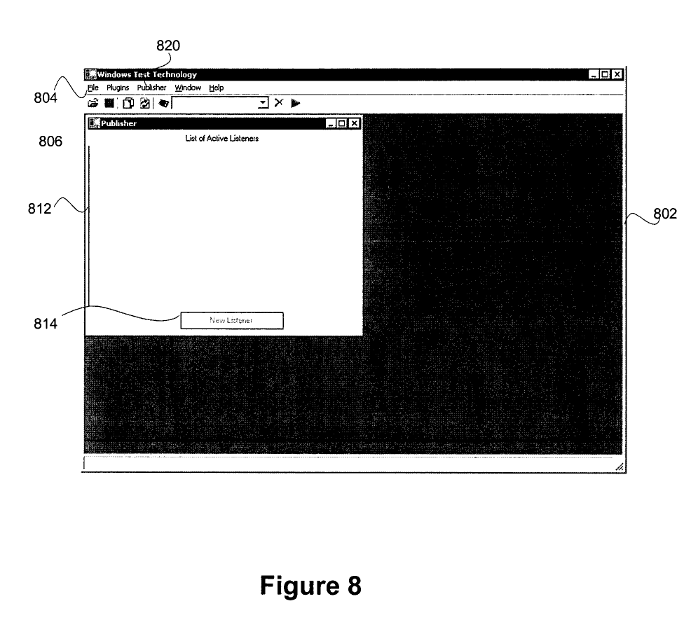

In FIG. 8, the ‘Publisher’ plug-in 820 has been started and the user interface shell 802 has been updated. As shown in FIG. 8, the menu bar 804 and the tool bar 806 may be customized based on the loading of the ‘Publisher’ plug-in 820. Also, a MDI window 812 entitled ‘Publisher’ may be opened and active. As further illustrated in FIG. 8, the a New listener button 814 may be grayed out as the ‘Publisher’ plug-in 820 may receive notification from the user interface framework 202 that a listener plug-in is not installed.

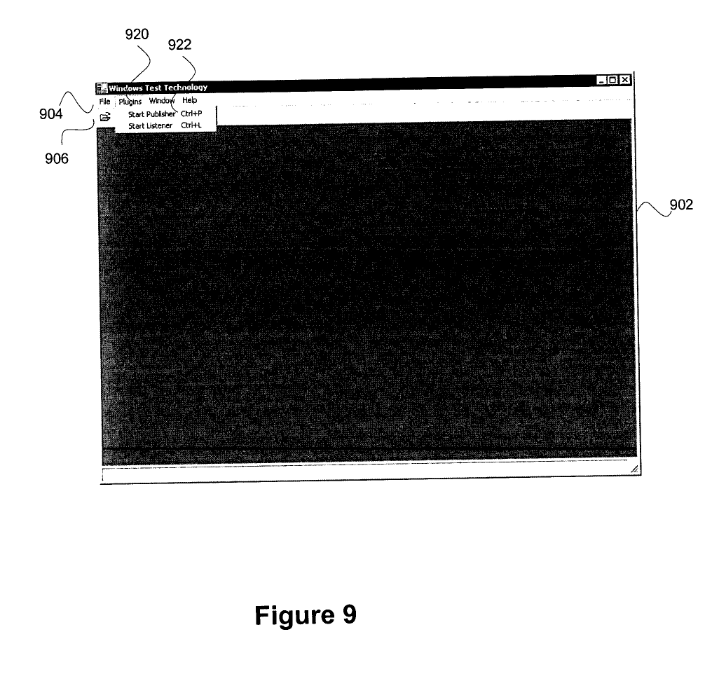

FIG. 9 illustrates the addition of a second plug-in to a plug-in directory in accordance with an embodiment of the invention. In FIG. 9, a plug-in named ‘Listener’ may be added to a Plugins directory 920 on menu bar 904. A list of the added plug-ins to the user interface shell 902 may be discovered through the use of drop down menu 922. As illustrated in FIG. 9, the user interface shell 902 may be updated or customized based upon the addition of the ‘Listener’ plug-in to the Plugins directory 920.

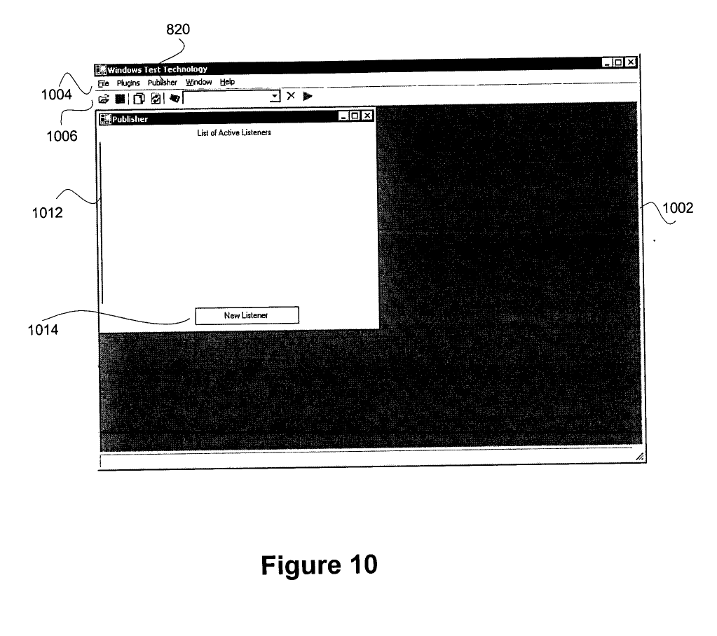

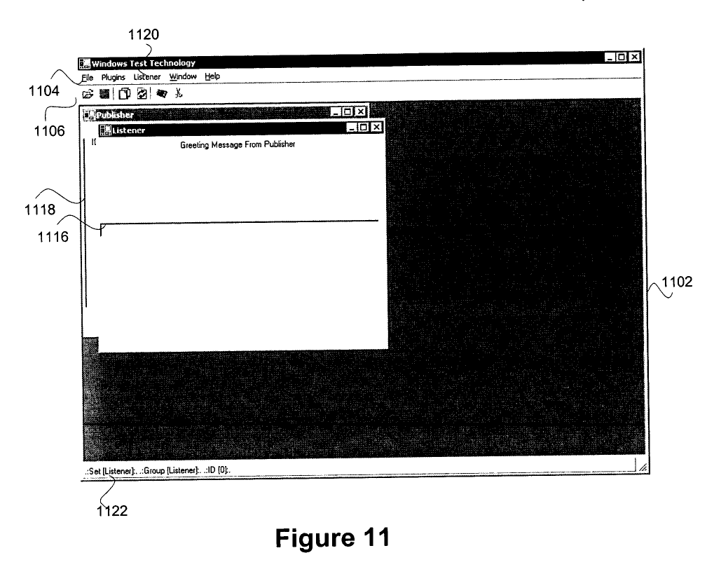

In FIG. 10 the ‘Publisher’ plug-in 820 may be activated and the user interface shell 1002 updated. As shown in FIG. 10, the menu bar 1004 and the tool bar 1006 may be updated and customized. In addition, a MDI window 1012 may indicate that the ‘Listener’ plug-in has been loaded as the New listener button 1014 is active. If the New listener button 1014 is selected a listener may be started as illustrated in FIG. 11. FIG. 11 illustrates that a new listener may have been started as indicated by MDI window 1116, and the placing of the publisher MDI window 1118 in the background. In addition, the menu bar 1104 may be updated to indicate that the Listener plug-in 1120 is active. Finally, a status bar 1122 on the user interface shell 1102 may also indicate that the Listener plug-in 1120 is active.

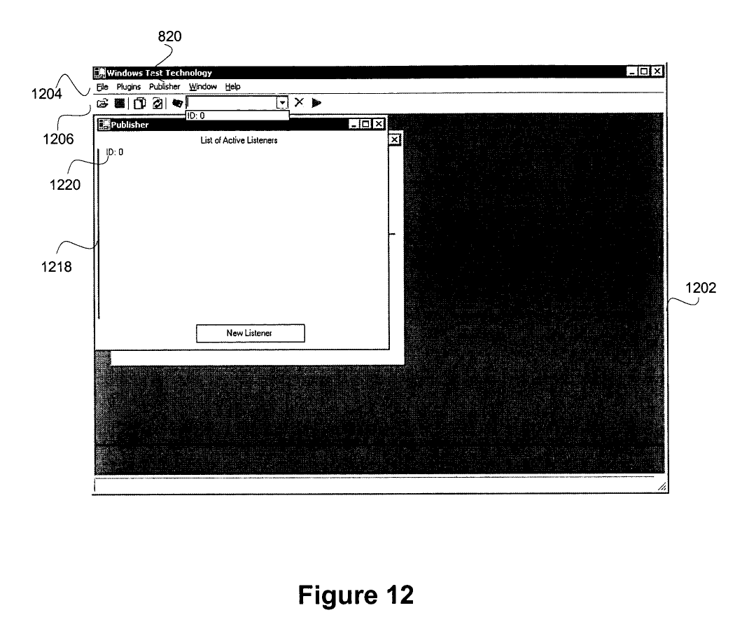

FIG. 12 illustrates that a plug-in may be activated by selecting the plug-ins MDI window. For example, in FIG. 12 the Publisher MDI window 1218 may be selected from the user interface shell 1202. When the Publisher MDI window 1218 is selected, the menu bar 1204 and tool bar 1206 are updated. In addition, the user interface framework may notify the Publisher plug-in 820 of the existence of a listener instance 1220.

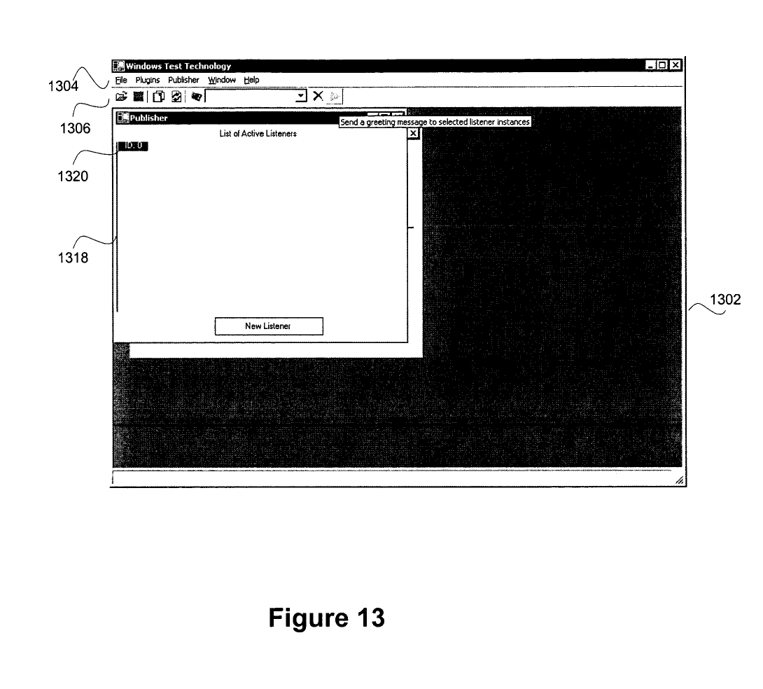

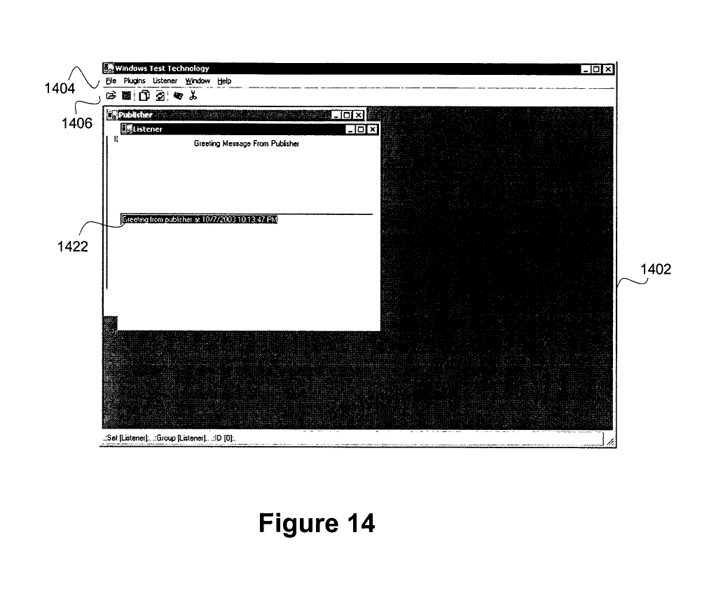

In FIG. 13, a listener instance 1320 may be selected in order to send a message. With the selection of the listener instance 1320 a send message tool bar button may be activated. In FIG. 14, a message may be delivered 1422 to a listener. The MDI window 1422 may illustrate the message.

The present invention has been described in terms of preferred and exemplary embodiments thereof. Numerous other embodiments, modifications and variations within the scope and spirit of the appended claims will occur to persons of ordinary skill in the art from a review of this disclosure.

Attached is an exemplary schema for the present invention:

1. A computer-implemented method of generating a componentized user interface, the method comprising:
(a) providing a first set of interface elements with a framework;
(b) providing a second set of interface elements with a first plug-in that is linked to the framework;
(c) providing a third set of interface elements with a second plug-in that is linked to the framework;
(d) hosting the first plug-in and the second plug-in with a shell linked to the framework, and
(e) providing an interface between the shell and the first plug-in and between the shell and the second plug-in with a shell adapter interface, in order to utilize the second set of interface elements and the third set of interface elements.

2. The computer-implemented method of claim 1, wherein the first plug-in comprises:
(i) a first file that provides an interface between the framework and the first plug-in; and
(ii) a second file written in a markup language and that includes menu elements.

3. The computer-implemented method of claim 2, wherein the menu elements are selected from the group consisting of a toolbar, a status bar, and a menu bar.

4. The computer-implemented method of claim 1, wherein the second plug-in comprises:
(i) a first file that provides an interface between the framework and the second plug-in; and
(ii) a second file written in a markup language and that includes menu elements.

5. The computer-implemented method of claim 4, wherein the menu elements are selected from the group consisting of a toolbar, a status bar, and a menu bar.

6. The computer-implemented method of claim 1, wherein the framework is configured to discover the first plug-in and the second plug-in.

7. The computer-implemented method of claim 6, wherein the framework further comprises a user interface component loader to load the first plug-in and the second plug-in.

8. The computer-implemented method of claim 2, wherein the first file comprises an executable file and the second file comprises an extensible markup language (XML).

9. The computer-implemented method of claim 2, wherein the first file comprises an executable file and the second file comprises a standard generalized markup language (SGML).

10. The computer-implemented method of claim 4, wherein the first file comprises an executable file and the second file comprises an extensible markup language (XML).

11. The computer-implemented method of claim 4, wherein the first file comprises an executable file and the second file comprises a standard generalized markup language (SGML).

12. The computer-implemented method of claim 1, wherein the framework is configured to provide the first set of interface elements for a plurality of applications

13. The computer-implemented method of claim 1, wherein the second set and the third set of interface elements comprise interface elements for the same application.

14. The computer-implemented method of claim 1, wherein the second set of interface elements comprises interface elements for a first application and the third set of interface elements comprise interface elements for a second application that is different from the first application.

15. A computer implemented method of providing extensibility to a user interface, the method comprising:
(a) providing a framework, the framework comprising a first set of interface elements and a user interface component loader, the framework configured to discover a plug-in located in a plug-in directory;
(b) loading the plug-in with the user interface component loader, the plug-in to provide a second set of interface elements;
(c) hosting the plug-in with a shell linked to the framework; and
(d) providing an interface between the shell and the plug-in with a shell adapter interface in order to utilize the second set of interface elements.

16. The computer-implemented method of claim 15, wherein the plug-in comprises:
(i) a first file that provides an interface between the framework and the plug-in; and
(ii) a second file written in a markup language and that includes menu elements.

17. The computer-implemented method of claim 16, wherein the menu elements are selected from the group consisting of a toolbar, a status bar, and a menu bar.

18. The computer-implemented method of claim 16, wherein the first file comprises an executable file and the second file comprises an extensible markup language (XML).

19. The computer-implemented method of claim 16, wherein the first file comprises an executable file and the second file comprises a standard generalized markup language (SGML).

20. The computer-implemented method of claim 15, wherein the framework is configured to provide the first set of interface elements for a plurality of applications.

21. The computer-implemented method of claim 15, wherein the method further comprises:
(e) loading a second plug-in with the user interface component loader, the second plug-in to provide a third set of interface elements;
(f) hosting the second plug-in with a shell linked to the framework; and
(g) providing an interface between the shell and the second plug-in with a second shell adapter interface in order to utilize the third set of interface elements.

22. The computer-implemented method of claim 21, wherein the second set and the third set of interface elements comprise interface elements for the same application.

23. The computer-implemented method of claim 21, wherein the second set of interface elements comprises interface elements for a first application and the third set of interface elements comprise interface elements for a second application that is different from the first application.

24. In a computer system having a graphical user interface including a display and a user interface selection device, a method of providing and selecting from a menu on the display, comprising the steps of:
(a) providing a first set of interface elements with a framework;
(b) retrieving a plug-in from a plug-in directory, the plug-in to provide a second set of interface elements, the plug-in capable of being utilized in a plurality of shells though the use of an adapter;
(c) displaying the plug-in on the display;
(d) receiving a plug-in selection entry signal indicative of the user interface selection device pointing at the plug-in on the display and in response executing the plug-in; and
(e) displaying at least a menu element associated with the plug-in.

25. The method of claim 24, wherein the menu element is selected from the group consisting of a toolbar, a status bar, and a menu bar.
